(19) United States
(12) Patent Application Publication
(10) Pub. No.: US 2005/0066890 A1
(43) Pub. Date: Mar. 31, 2005

(54) Device for treating the surface of workpieces, in particular of vehicle bodies

(76) Inventor: Achim Wetzel, Bietigheim-Bissingen (DE)

Correspondence Address: FACTOR & LAKE, LTD, 1327 W. WASHINGTON BLVD., SUITE 5G/H, CHICAGO, IL, 60607, US

(21) Appl. No.: 10/917,271

(22) Filed: Aug. 12, 2004

(30) Foreign Application Priority Data
Aug. 14, 2003 (DE) 103 37 803.0

(51) Int. Cl. B25J 5/04; B23Q 3/02

(52) U.S. Cl. 118/313; 118/668

(57) ABSTRACT

A device for treating the surface of workpieces, in particular of vehicle bodies, includes a gantry in the form of a frame. The latter has a through opening into which a workpiece may be introduced. At least one guide rail is secured to the gantry and is guided around the workpiece in an arc or circle shape. At least one carriage may be moved preferably by motor along the guide rail and carries a holding arm for the tool. This holding arm is constructed such that the tool is movable in the direction of the workpiece and may be brought into various angular positions in relation to the surface of the workpiece. In addition, a device is provided by means of which a relative movement may be performed between the workpiece and the tool in the axial direction of the through opening. This device is very versatile and makes possible a rapid movement of the tool at high speed and with high dynamics and a high level of precision.

### BACKGROUND

The invention relates to a device for treating the surface of workpieces, in particular of vehicle bodies, having
a) a tool acting on the surface of the workpiece; and
b) a guide device for the tool which is controllable such that the tool follows a predetermined line.

In the widest range of industrial fields it is necessary to work on the surface of relatively large, long and/or complexly shaped workpieces. This is true for example and in particular of the manufacture of vehicle bodies. In the present document, the term “surface treatment” includes all those procedures which act not on the material of the workpiece but are limited to the surface of these workpieces. In particular, possible procedures include adhesion, the sealing of seams, the application of a coating, wax or insulating film, the curing of an applied film, in particular under the effect of UV rays, washing or cleaning. The tool used in each case is matched to the treatment procedure concerned. Thus, for example, to apply films to the workpiece spray guns or other application equipment is used; for washing, spray or flooding nozzles are used; for cleaning, brushes or springs; and for UV curing, UV lamps are used as the tool. Because the tool is small in relation to the surface of the workpiece, it has to be moved along a predetermined line relative to the workpiece while the work procedure is being carried out.

Where surface treatments of this kind have been automated at all hitherto and are not carried out by hand, in general robots having multiaxial robot arms are generally used. So that the surface of these large workpieces can be reached all over, the robot arms have to be relatively long and hence heavy. However, this means that the speed and dynamics at which the tools carried at the end of the robot arm are moved are only limited. The precision with which the movement is performed is also impaired with very long robot arms.

The object of the present invention is to provide a device of the type mentioned at the outset in which a very fast movement, performed with high dynamics and precision, of the tool carrying out the surface treatment is possible.

This object is achieved in accordance with the invention in that the guide device includes:
c) a gantry in the form of a frame which for its part has:
   ca) a through opening into which a workpiece may be introduced;
   cb) at least one guide rail which is secured to the gantry and is guided around the workpiece in an arc or circle shape;
   cc) at least one carriage which may be moved preferably by motor along the guide rail;
   cd) a holding arm which is secured to the carriage and carries the tool at its free end, and which is constructed such that the tool is movable in the direction of the workpiece and may be brought into various angular positions in relation to the surface of the workpiece;
d) a device by means of which a relative movement may be performed between the workpiece and the tool in the axial direction of the through opening.

The core of the present invention is the gantry in the form of a frame, in the through opening whereof the workpiece is positioned during the surface treatment. With the aid of the carriage, which may be moved on the guide rail of the gantry and which carries the tool by way of the holding arm, and with the aid of the device which makes a relative movement between the tool and the workpiece possible in the direction of the axis of the through opening, the tool can be brought into an initial position at the start of the treatment procedure, from which, during the actual surface treatment, the tool then reaches all the surface regions which are to undergo treatment, along a short route. Only as an exception is a movement of the carriage along the gantry or a relative movement reaching beyond the range of the holding arm itself between the workpiece and the tool in the axial direction of the through opening necessary during the surface treatment itself. In this way, the holding arm can be constructed to be relatively short.

The masses that have to be accelerated when the holding arm is moved are relatively small, with the result that high speeds and rapid accelerations and decelerations can be achieved. The relatively small length of the holding arm moreover ensures that movement is performed with great precision.

Depending on the type of workpiece, the guide rail on which the carriage carrying the holding arm may be moved can surround the workpiece along only an arc or indeed in a complete circle.

Because, in many surface treatments, the orientation at which the tool acts on the surface of the workpiece is significant, the holding arm carrying the tool has those degrees of freedom which make it possible not only to guide the tool along a particular line but also to adjust a desired orientation of the tool at any point on its path of movement.

The holding arm may be a multiple-member robot arm. Robot arms of this kind and controls therefor are commercially available.

The device for generating the relative movement may be constructed such that it can move the gantry as a whole. The initial position of the tool in the direction of the axis of the through opening of the gantry is thus brought about by the entire gantry being moved accordingly. A movement of the gantry during the surface treatment itself is carried out, as already mentioned above, only in exceptional cases, if the range of the holding arm in the direction of the axis of the through opening is not sufficient.

The device for generating the relative movement may also be constructed such that it can move the workpiece in relation to the gantry. Here too it is the case that movement of the workpiece in relation to the gantry typically only serves to set up the starting position of the tool.

In another example embodiment of the invention, the device for generating the relative movement is constructed such that it can move the tool in the direction of the axis of the through opening of the gantry. This embodiment has the advantage that those parts which have to be moved parallel to the axis of the through opening, namely the holding arm and the tool itself, are relatively lightweight and hence the means which are used to generate the axially parallel movement can be kept relatively simple.

In this context, in particular an embodiment of the invention is possible in which the device for generating the relative movement is formed by the holding arm itself, which for this purpose comprises at least four mutually connected members, where:
a) the first member is secured to the carriage such that it may be rotated by motor about an axis which runs in the azimuthal direction in relation to the through opening of the gantry;
b) the second member is secured to the first member such that it may be rotated by motor about an axis which also runs in the azimuthal direction in relation to the through opening of the gantry;
c) the third member is secured to the second member such that it may be rotated by motor about the axis of the second member; and
d) the fourth member, carrying the tool, is rotatable on the third member about an axis which runs perpendicular to the axis of the third member.

The holding arm which is constructed in this way substantially corresponds to a conventional four-axis robot arm, with the mobility of the carriage carrying the holding arm coming into play along the guide rail as a fifth degree of freedom of movement (“fifth axis”). The term “azimuthal” here means a direction which lies substantially in a plane parallel to the plane of the gantry and runs substantially perpendicular to the direction in which the tool is moved towards the workpiece. When the gantry is guided in an arc shape, the azimuthal direction is therefore perpendicular to the radial direction.

The mobility and range of the holding arm are further increased in the embodiment of the invention in which the first member is secured to the carriage indirectly, by way of a swivel block which is rotatable about an axis substantially parallel to the axis of the through opening. In this embodiment, the pivot axes of the first two members of the holding arm are only aligned azimuthally in a particular position of the swivel block. If the swivel block is rotated out of this position, they migrate out of the azimuthal alignment, but at the same time remain in a plane parallel to the plane of the gantry.

The device for generating relative movement may alternatively also include a carriage which is movable by motor parallel to the axis of the through opening, which is secured to the carriage movable on the guide rail, and on which the holding arm is mounted. In this case, therefore, the relative movement between the workpiece and the tool, parallel to the axis of the through opening of the gantry, is brought about by an axial movement of the second carriage holding the holding arm and hence the tool.

The gantry may carry a respective guide rail on each opposing end face, and at least one carriage carrying a holding arm is movable on each of these guide rails. In this way, a plurality of carriages and hence tools may be mounted on one and the same gantry and be movable independently of one another. This increases the capacity of the device overall; large workpieces can be worked on more quickly.

The same object is served by the embodiment of the invention in which at least one guide rail is provided on which a plurality of carriages carrying a holding arm and hence a tool are movable. The path of movement by each carriage on this guide rail is of course limited in each case by the position of the other carriage or carriages which move(s) on the same guide rail.

In many cases, it is sufficient if the guide rail is curved, in the shape of a circle or an arc, for all the surface regions of the workpiece to be reachable substantially to the same extent. With a very irregularly shaped workpiece, however, it is also possible to match the shape of the guide rail surrounding the workpiece to the contour of the workpiece. In this case, for example, straight sections may be inserted between curves, which need not be arcs, with the result that the guide rail runs along the entire periphery or part of the periphery of a rounded polygon, for example a rectangle, a triangle or the like.

### DESCRIPTION OF THE DRAWINGS

An example embodiment of the invention will be explained in more detail below with reference to the drawing, in which:

FIG. 1 shows in perspective a device for applying streaks of adhesive to a vehicle body;

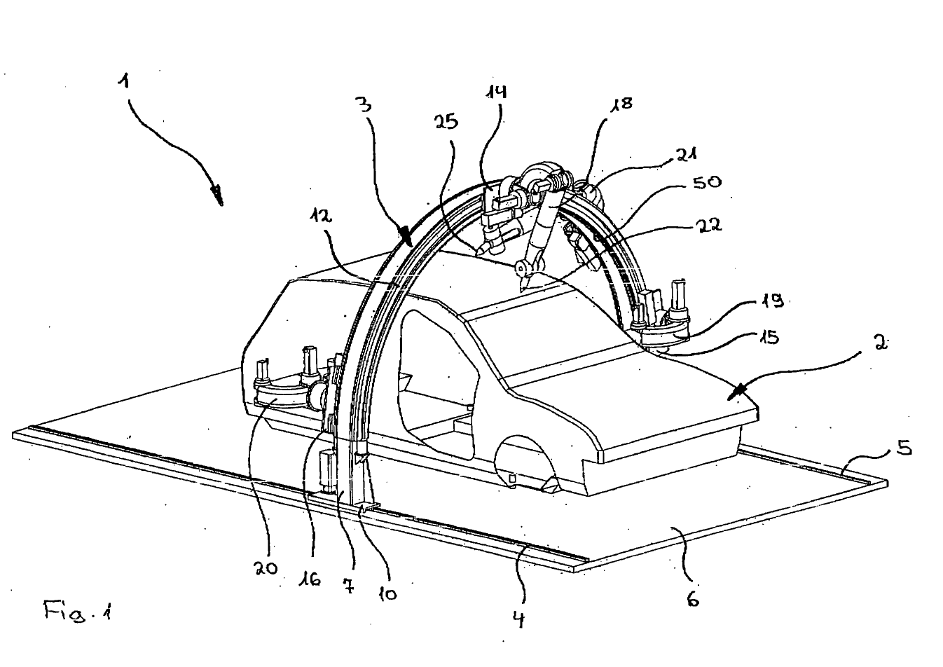

FIG. 2 shows another perspective of the device from FIG. 1;

FIG. 3 shows a front view of the device from FIGS. 1 and 2;

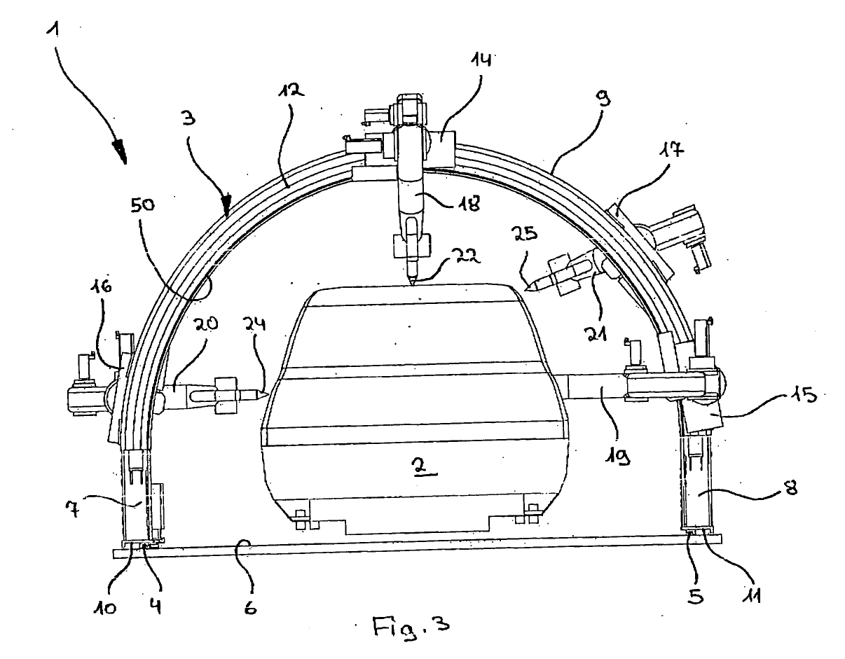

FIG. 4 shows a rear view of the device from FIGS. 1 to 3;

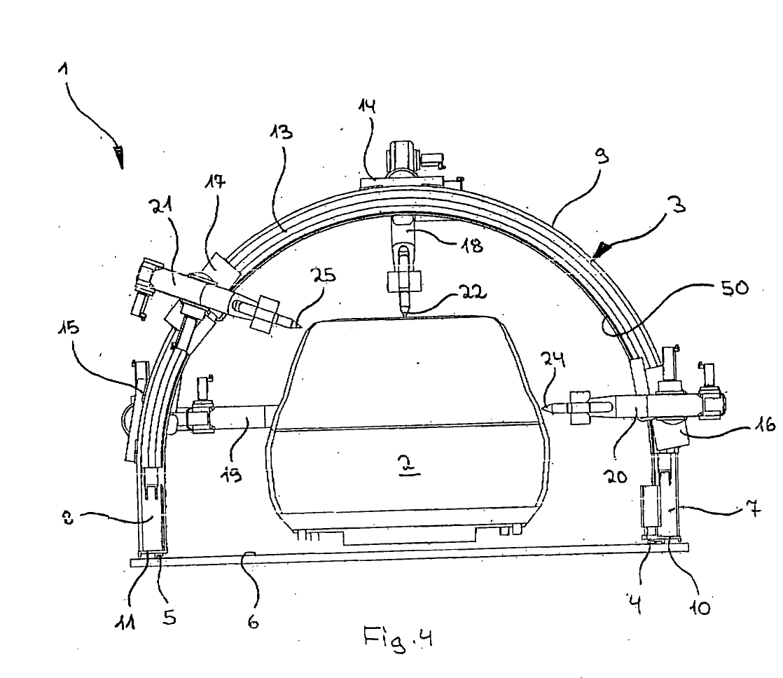

FIG. 5 shows a side view of the device from FIGS. 1 to 4;

FIG. 6 shows a plan view of the device from FIGS. 1 to 5; and

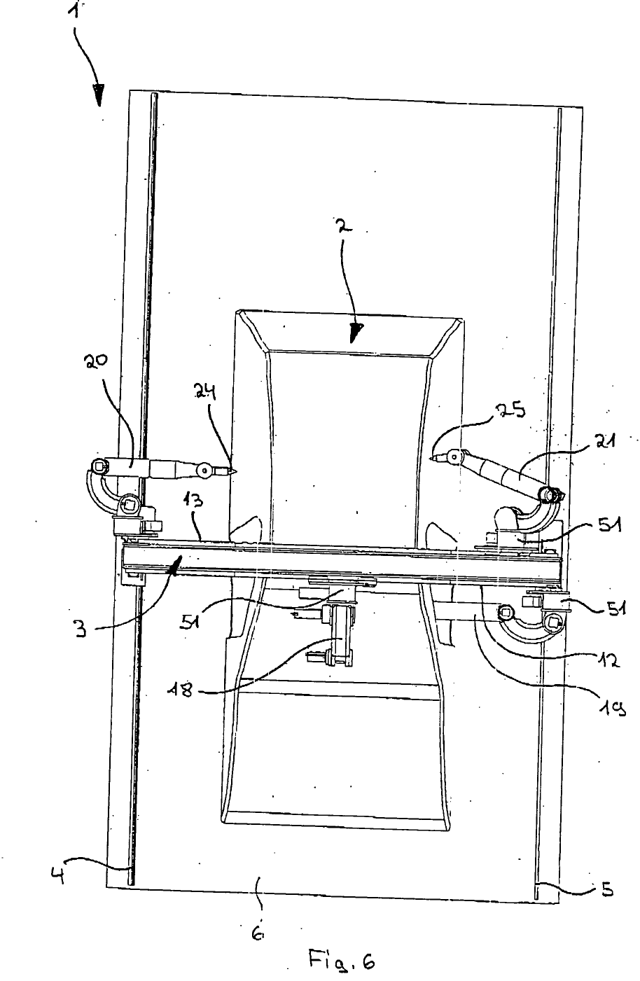

FIG. 7 shows, in an enlarged perspective view, a detail of the device from FIGS. 1 to 6 in the region of a holding arm.

### DETAILED DESCRIPTION OF THE DRAWINGS

The device illustrated in the drawing and designated overall by the reference numeral 1 serves to apply streaks of adhesive or sealant to vehicle bodies 2, following more or less complicated lines, closed or otherwise, on external or internal surface regions of the respective vehicle body 2. The device 1 has a gantry 3 having a through opening 50 which spans the vehicle body 2 positioned in the through opening 50 and is at the same time at an approximately constant spacing therefrom.

The gantry 3 is movable by motor along two rails 4, 5 which extend parallel on either side of the vehicle body 2 on the area base 6. It includes two relatively short vertical columns 7, 8 which are connected at their upper ends by a semi-circular carrying structure 9. The columns 7, 8 are provided at their lower ends with travelling mechanisms 10, 11 which are illustrated only diagrammatically in the drawing and enable the gantry 3 to be moved on the rails 4 and 5.

Secured both to the front and to the rear end face of the semi-circular carrying structure 9 is a respective guide rail 12 and 13, also semi-circular. Two carriages 14, 15, 16, 17 are movable on each of these guide rails 12, 13 respectively and each carries a robot arm 18, 19, 20, 21 serving as a holding arm. Each of these robot arms 18, 19, 20, 21 holds an adhesive or sealant gun 22, 23, 24, 25 at its free end. For the sake of simplicity, only one adhesive gun will be discussed below.

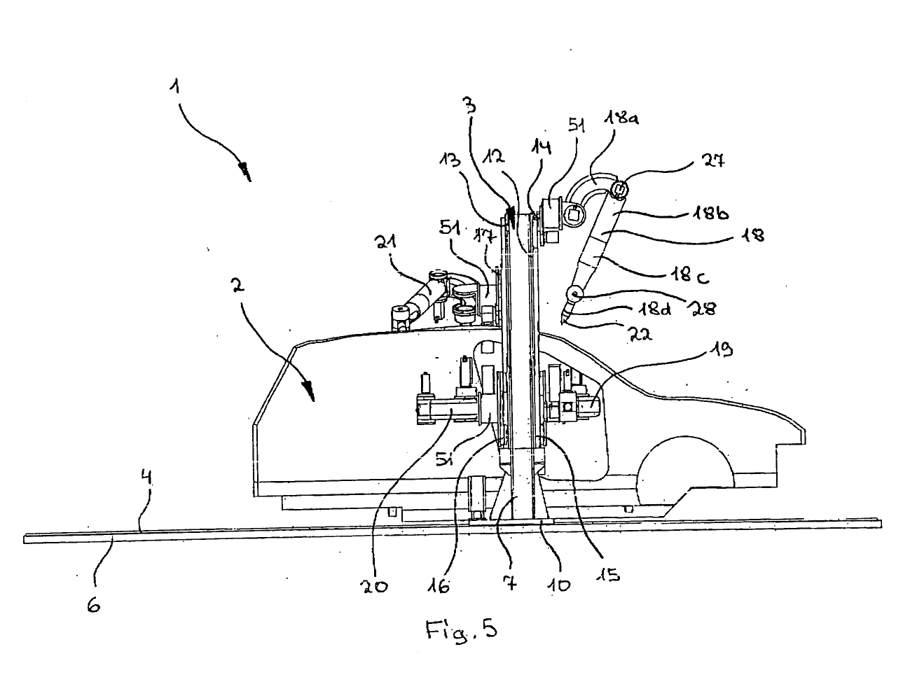

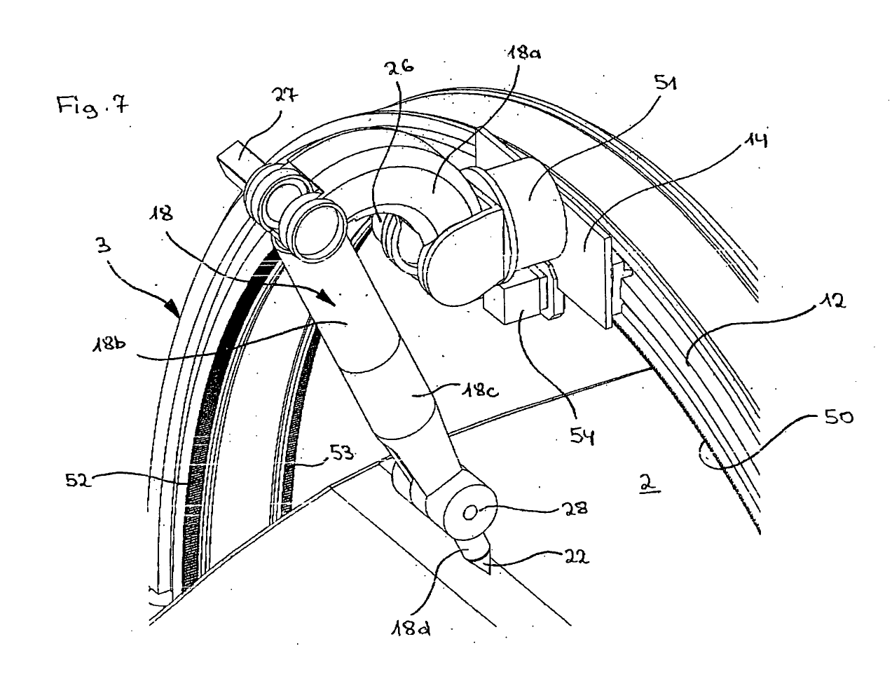

All the robot arms 18 to 21 are identical in construction. The way they are constructed will be described in more detail below with reference to FIGS. 5 and 7 for the robot arm 18.

The robot arm 18 includes a total of four members: a first member 18a which is curved into a circle quadrant and is connected at its one end in articulated manner to a swivel block 51 which, for its part, is secured to the carriage 14 such that it is rotatable about an axis running parallel to the axis of the through bore 50. This rotary movement is performed with the aid of a motor, not visible in the drawing. The pivotal movement of the first member 18a with respect to the swivel block 51 is brought about with the aid of a motor 26. The pivot axis in this case runs in a plane parallel to the plane spanned by the gantry 3, and when the swivel block 51 is in the position illustrated in the drawing this pivot axis stands substantially perpendicular to the radial direction in relation to the semi-circular carrying structure 9. This direction is called “azimuthal” in the present document. When the swivel block 51 is rotated out of this position, the pivot axis comes out of the azimuthal alignment but remains in a plane substantially parallel to the plane spanned by the gantry 3.

A second member 18b is articulated to the second end region of the first member 18a. This pivotal movement is performed under the action of a motor 27. The pivot axis concerned is parallel to the first pivot axis acting between the first member 18a and the swivel block 51. The third member 18c of the robot arm 18 coaxially continues the second member 18b and is rotatable by motor about the common axis. The motor concerned is not visible in the drawing. Articulated to the external end of the third member 18c is a fourth member 18d which may be pivoted with the aid of a motor 28. The pivot axis concerned runs perpendicular to the axis of the members 18b and 18c. The fourth member 18d carries the spray gun 22 at its free end.

As can be seen in particular from FIG. 7, two toothed racks 52, 53 curved into the shape of an arc are mounted on the inside casing face of the semi-circular carrying structure 9. These toothed racks 52, 53 cooperate with drive pinions of motors 54, by means of which the carriages 14, 15, 16, 17 are movable on the guide rails 12, 13. The toothed racks 52, 53 may alternatively also be secured to the outside casing face or the end faces of the carrying structure 9.

The robot arm 18 described, and hence each robot arm 18 to 21 of the device 1, thus have six degrees of freedom, or to use the terminology of robotics six “axes”: one degree of freedom which corresponds to the movement of each carriage 14 to 17 along the appropriate guide rail 12, 13, three degrees of freedom of pivoting and two degrees of freedom of rotation. In this way, it is possible for each robot arm 18 to 23 to follow, within a particular region, with the tip of the adhesive gun 22 to 25 a pre-programmed line on the surface of the vehicle body 2 and at the same time moreover to retain a desired orientation of the adhesive gun 22c to 25 with respect to the surface of the vehicle body 2.

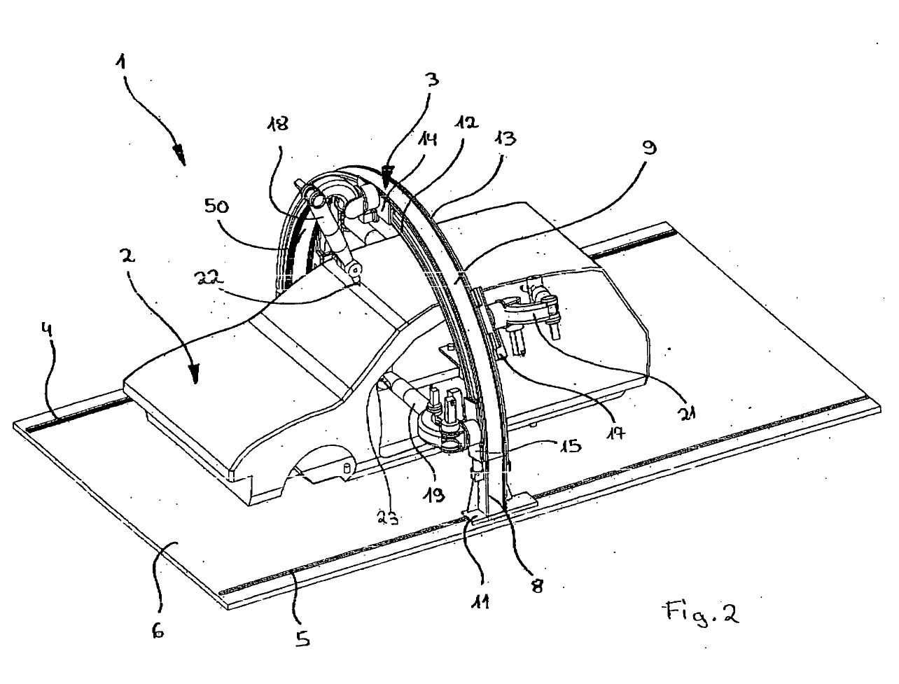

In this, not only external but also internal surface regions of the vehicle body 2 can be reached. Thus, and as is particularly clear from FIG. 2, the holding arm 19 extends through a window in the vehicle body into the interior thereof in order to apply a streak of adhesive there.

The device 1 described above operates as follows.

The vehicle body 2 is put into the through opening 50 in the gantry 3, under the carrying structure 9, and put roughly in position there with the aid of a transport system, not illustrated in the drawing. The gantry 3 is then moved such that as many as possible of the lines to be provided with adhesive on the vehicle body 2 are located in the region of the robot arms 18 to 21. With the aid of the carriages 14 to 17, the robot arms 18 to 21 are positioned along the guide rails 12, 13 such that they can reach all the regions of the respective adhesive lines pointing towards them, through their six degrees of freedom of movement. The adhesive guns 22 to 25 are now operated and, with the aid of the robot arms 18 to 21, are guided along the respective adhesive line.

In this way it is possible to use relatively short robot arms 18 to 21 which can operate with a high level of dynamics, at high speed and with a high degree of precision. Because of the gantry-like guide rails 12, 13, in this arrangement all the surface regions of the vehicle body 2 are readily accessible over a short route.

Normally, the movements of the robot arms 18 to 21 are carried out with the vehicle body 2 at a standstill, with the gantry 3 at a standstill and with the carriages 14 to 17 at a standstill. In this way, the high level of dynamics, the high speed and the high degree of precision of the relatively small robot arms 18 to 21 can be used to the optimum. It is, however, also possible, in the case of adhesive lines which reach beyond the range of the individual robot arms 18 to 21, to overlay the movement of the robot arms 18 to 21 with respect to their associated carriages 14 to 17 with a translational movement of the vehicle body 2, with the aid of the transport system (not illustrated), and/or a translational movement of the gantry 7 on the carriages 4, 5 and/or by a movement of the carriages 14 to 17 on the guide rails 12, 13.

In an example embodiment not illustrated in the drawing, the guide rails do not only have the shape of semi-circular arcs but surround the workpiece that is to undergo work on all sides, in the manner of a ring. The shape of the guide rails may also differ from a circular or arcuate shape, depending on the workpiece. For example, straight sections may be inserted between curved sections of the guide rails and thus shapes similar to polygons, for example approximately rectangular or triangular, of the guide rails may be used if this allows the approximately constant spacing between the guide rails and the workpiece that is to undergo work to be retained better.

1. A device for treating the surface of workpieces, such as vehicle bodies, comprising:
a) a tool acting on the surface of the workpiece; and
b) a guide device or the tool which is controllable such that the tool follows a predetermined line;
wherein the guide device includes:
c) a gantry in the form of a frame which for its part has:
ca) a through opening into which a workpiece may be introduced;
cb) at least one guide rail which is secured to the gantry and is guided around the workpiece in an arc or circle shape;
cc) at least one carriage which may be moved preferably by motor along the guide rail; and
cd) a holding arm which is secured to the carriage and carries the tool at its free end, and which is constructed such that the tool is movable in the direction of the workpiece and may be brought into various angular positions in relation to the surface of the workpiece; and
d) means for performing a relative movement between the workpiece and the tool in the axial direction of the through opening.

2. A device according to claim 1, wherein the holding arm is a multiple-member robot arm.

3. A device according to claim 1, wherein the device for generating the relative movement means is constructed such that it can move the gantry as a whole.

4. A device according to claim 1, wherein the device for generating the relative movement means is constructed such that it can move the workpiece in relation to the gantry.

5. A device according to claim 1, wherein the relative movement means is constructed such that it can move the tool in the direction of the axis of the through opening of the gantry.

6. A device according to claim 5, wherein the device for generating the relative movement means is formed by the holding arm itself, which further comprises at least four mutually connected members, where:
a) the first member is secured to the carriage such that it may be rotated by motor about an axis which runs in the azimuthal direction in relation to the through opening of the gantry;
b) the second member is secured to the first member such that it may be rotated by motor about an axis which also runs in the azimuthal direction in relation to the through opening of the gantry;
c) the third member is secured to the second member such that it may be rotated by motor about the axis of the second member; and
d) the fourth member, carrying the tool, is secured to the third member such that it may be rotated about an axis which runs perpendicular to the axis of the third member.

7. A device according to claim 6, wherein the first member is secured to the carriage indirectly, by way of a swivel block which is rotatable about an axis substantially parallel to the axis of the through opening of the gantry.

8. A device according to claim 5, wherein the device for generating relative movement means includes a carriage which is movable by motor parallel to the axis of the through opening, which is secured to the carriage movable on the guide rail, and on which the holding arm is mounted.

9. A device according to claim 1, wherein the gantry carries a respective guide rail on each opposing end face, and at least one carriage carrying a holding arm is movable on these.

10. A device according to claim 1, wherein at least one guide rail is provided on which a plurality of carriages carrying a holding arm are movable.

11. A device according to claim 1, wherein the shape of the guide rail is matched to the contour of the workpiece.
